(19) United States
(12) Patent Application Publication
(10) Pub. No.: US 2008/0097800 A1
(43) Pub. Date: Apr. 24, 2008

(54) SYSTEM AND METHOD FOR MARKETING AND DEVELOPING A CUSTOM SUBSTATION

(76) Inventors: Krassimir G. Kutlev, Cary, NC (US); Richard L. Auerweck, Holly Springs, NC (US); Ernst Scholtz, Raleigh, NC (US); Ulf G. Andersson, Raleigh, NC (US)

Correspondence Address: RENNER, OTTO, BOISSELLE & SKLAR, LLP (ABBI), 1621 EUCLID AVENUE, 19TH FLOOR, CLEVELAND, OH, 44115, US

(21) Appl. No.: 11/551,896

(22) Filed: Oct. 23, 2006

(51) Int. Cl. G06F 9/44

(52) U.S. Cl. 705/7

(57) ABSTRACT

A computer implemented method of marketing an electricity distribution and transmission substation to a customer by a substation vendor. The method includes collecting functional information relating to intended use and location of the substation. The method also includes identifying at least one substation configuration from a database of plural substation configurations, where the identified substation configurations have at least some suitability for satisfying the collected functional information. The identification is made by an expert system that matches the functional information with predetermined characteristics of each of the plural substation configurations.

### FIELD OF THE INVENTION

The present invention relates generally to electrical power systems and, more particularly, to a system and method for developing and marketing a custom substation configuration for a potential customer.

### BACKGROUND OF THE INVENTION

Substations that form part of an electrical power transmission and distribution system are generally used to switch power circuits and transform power from one voltage to another. Substations may include various equipment such as switches, circuit breakers, buses and transformers. Substations are often customized for a specific user of electric power. Factors such as the type of end user (e.g., investor owned utility, municipality, commercial establishment, manufacturing facility, etc.), the functional demands of the end user, the environmental conditions at the planned substation site, and the geographic location of the planned substation are considered when designing a substation.

There are two common substation marketing situations that occur between a substation vendor and a substation customer. The first situation is when the customer specifies a predetermined substation configuration to the vendor. The vendor, in turn, provides a quotation to construct the substation. In this situation, the customer has predetermined the substation configuration, and little or no customization of the substation by the vendor typically takes place.

The second situation is when the customer is planning a substation project and approaches the vendor for a quotation for a substation that meets the customer's functional requirements (e.g., criteria specified by the customer). In the second situation, the customer often relies on the experience and expertise of the vendor to deliver a quotation based on a substation that is customized for the customer. The practice of communicating with the customer early in the substation project process is commonly referred to in the industry as a “front end sales process.”

As will be appreciated, a great deal of engineering may be involved with designing a custom substation before a preliminary quotation may be made. For instance, the applicants contemplate that there may be a hundred or more possible ways to configure a substation. In addition, substations are often designed in modular format where predetermined groups of equipment used for accomplishing a certain task may make up a substation module. There may be a few hundred possible substation modules, and each module may have a number of variations. Some modules may be useable in multiple substation configurations. Since there are such a large number of possible substation configurations and each substation configuration may be constructed from a large number of different modules, a sales engineer representing a substation vendor may have a difficult time generating a suitable substation upon which an accurate quotation may be generated. While detailed substation design may be carried out by an engineering department of a substation vendor so that an accurate quotation may be generated, such design efforts are time consuming and expensive.

### SUMMARY

To improve the front end sales process for a substation, there is a need in the art for a system and method for marketing and developing a custom substation using the experience of a substation vendor. Upon establishment of a preliminary substation configuration that is made up of a substation modules, an initial budget quotation may be provided to the customer. Additional engineering may be conducted to enhance the preliminary substation configuration and generate a firm quotation for presentation to the customer.

According to one aspect of the invention, a computer implemented method of marketing an electricity distribution and transmission substation to a customer by a substation vendor includes collecting functional information relating to intended use and location of the substation; and identifying at least one substation configuration from a database of plural substation configurations, the identified substation configurations having at least some suitability for satisfying the collected functional information, and wherein the identification is made by an expert system that matches the functional information with predetermined characteristics of each of the plural substation configurations.

According to one embodiment of the method, the predetermined characteristics of each of the plural substation configurations includes at least one substation market for the substation configuration.

According to one embodiment of the method, each substation market is based on at least one factor selected from intended electricity use, geographic location, environmental conditions, government regulations and combinations thereof.

According to one embodiment of the method, each of the plural substation configurations is made up of a predetermined set of modules.

According to one embodiment, the method further includes, for at least one of the identified substation configurations, determining an alternative module for one of the predetermined modules that makes up the identified substation configuration.

According to one embodiment, the method further includes converting the collected functional information to engineering information, the expert system using the engineering information as the basis for the matching of the functional information with the predetermined characteristics of each of the plural substation configurations.

According to one embodiment, the method further includes displaying a graphical representation of a selected one of the identified substation configurations.

According to one embodiment of the method, the displaying is associated with a graphical user interface that accepts and stores a comment associated with the displayed graphical representation.

According to one embodiment, the method further includes generating a preliminary budget quotation for a selected one of the identified substation configurations.

According to one embodiment, the method further includes customizing a selected one of the identified substation configurations based on the functional information to generate an engineered substation configuration that is adapted for the customer.

According to one embodiment, the method further includes generating a budget quotation for the engineered substation configuration.

According to one embodiment of the method, the collecting of function information includes receiving answers to questions contained in an automated question script.

According to one embodiment of the method, the functional information includes at least one of the answers or data derived by processing the answers.

According to one embodiment, the method further includes calculating lifecycle costs of the identified substation configurations based on the functional information and presenting the calculated lifecycle costs to the customer as part of a comparative analysis of the identified substation configurations.

According to another aspect of the invention, a computer implemented method of marketing an electricity distribution and transmission substation to a customer by a substation vendor includes storing a substation configuration database containing plural predetermined substation configurations; and for each substation configuration, associating one or more substation customer markets for which the substation configuration has at least some suitability, the associated substation customer markets based on at least one factor selected from intended electricity use, geographic location, environmental conditions, government regulations and combinations thereof.

According to one embodiment of the method, each of the plural predetermined substation configurations is made up of a predetermined set of modules.

According to one embodiment of the method, for at least some of the substations configurations the method further includes storing an identity of an alternative module that is compatible with the substation configuration as a potential replacement to a module from the corresponding predetermined set of modules.

According to another aspect of the invention, a computer implemented substation marketing and development tool for use in marketing a custom electricity distribution and transmission substation to a customer by a substation vendor includes a substation configuration database stored by a memory, the database containing plural predetermined substation configurations; and a program embodied on a machine readable medium. The program contains executable logic to collect functional information relating to intended use and location of the substation; and identify at least one substation configuration from the database that has at least some suitability for satisfying collected functional information, and wherein the identification is made by an expert system that matches the functional information with predetermined characteristics of each of the plural substation configurations.

According to one embodiment of the substation marketing and development tool, the predetermined characteristics of each of the plural substation configurations includes at least one substation market for the substation configuration.

According to one embodiment of the substation marketing and development tool, each substation market is based on at least one factor selected from intended electricity use, geographic location, environmental conditions, government regulations and combinations thereof.

According to one embodiment of the substation marketing and development tool, each of the plural substation configurations is made up of a predetermined set of modules.

According to one embodiment of the substation marketing and development tool, the program further includes executable logic to determine an alternative module for one of the predetermined modules that makes up at least one of the identified substation configurations.

According to one embodiment of the substation marketing and development tool, the program further includes executable logic to convert collected functional information to engineering information, the expert system configured to use the engineering information as the basis for the matching of the functional information with the predetermined characteristics of each of the plural substation configurations.

According to one embodiment of the substation marketing and development tool, the program further includes executable logic to display a graphical representation of a selected one of the identified substation configurations.

According to one embodiment of the substation marketing and development tool, the program further includes executable logic to accept and store a comment in association with the displayed graphical representation.

According to one embodiment of the substation marketing and development tool, the program further includes executable logic to generate a budget quotation for a selected one of the identified substation configurations.

According to one embodiment of the substation marketing and development tool, the logic to collect functional information generates an automated question script.

According to one embodiment of the substation marketing and development tool, the program further includes executable logic to calculate lifecycle costs of the identified substation configurations based on the functional information and present the calculated lifecycle costs to the customer as part of a comparative analysis of the identified substation configurations.

These and further embodiments will be apparent with reference to the following description and attached drawings. In the description and drawings, particular embodiments have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic block diagram of an exemplary computer system that may be used to implement a system for marketing a custom substation in accordance with the present invention;

FIG. 2 is a schematic block diagram of an exemplary custom substation marketing and development tool;

FIG. 3 is a flow chart representing a project planning phase and a project development phase of an exemplary method of marketing and developing a custom substation;

FIG. 4 is a flow chart representing a project engineering and a project offering phase of an exemplary method of marketing and developing a custom substation; and

FIG. 5 is an exemplary single line drawing (SLD) generated using the custom substation marketing and development tool and showing a representative substation configuration.

### DETAILED DESCRIPTION OF EMBODIMENTS

Exemplary embodiments of the invention will now be described with reference to the drawings, wherein like reference numerals are used to refer to like elements throughout. It will be understood that the figures are not necessarily to scale.

### A. Introduction

The methods and systems described herein relate to the marketing and/or development of a custom substation for use as part of an electricity transmission and distribution system. The methods and systems have particular application to a front end sales process between a substation vendor and a substation customer, but may have application in other contexts. For purposes of the description herein, an exemplary customer will be an entity interested in purchasing a substation through which electrical power will be delivered to the customer for consumption. The customer may be any electricity consumer, such as a municipality, an investor owned utility, a cooperative, or a commercial or industrial consumer.

For purposes of the description herein, an exemplary vendor will be an established company that has experience in designing and installing custom substations. The exemplary vendor may have marketing personnel, such as sales engineers, who are trained to meet with customers throughout the front end sales process. The exemplary vendor also may have substation design engineers who are skilled in designing a substation. The knowledge and experience of the vendor may be applied through the methods and systems described herein to market and/or develop a custom substation that meets substation criteria specified by the customer. The customer specified criteria may include functional requirements for the substation, which are the customer's desired operational and performance characteristics for the substation. The functional requirements may be effected by external factors, such as environmental conditions and government regulations.

The marketing of a custom substation through interaction between the vendor and the customer, or front end sales process, often includes various phases, including project planning, initial project development and offering, project engineering, and final project offering and negotiation. The project planning phase may involve collecting information from the customer, including functional requirements and data related to the proposed substation project. The initial project development and offering phase may involve using the collected information to arrive at one or more substation configurations. During this phase, a plurality of substation configurations that satisfy a majority of the customer's functional requirements may be determined. A technical, reliability and/or economic analysis then may be conducted to reduce the number of substation configurations to one or more substation configurations for which a preliminary budget quotation may be generated. The project engineering phase may involve refining at least one of the substations configurations to address the customer's functional requirements and any customer comments generated during the earlier phases to arrive at a custom substation configuration. The project offering phase may involve making a budget quotation to the customer for the custom substation configuration and conducting negotiations to complete the front end sales process. The initial project development and offering phase and/or the project engineering phase may be repeated one or more times to iteratively develop a substation configuration that suits the customer's functional requirements and/or to resolve customer concerns.

The methods and systems may be implemented using a custom substation marketing and development tool that includes executable instructions (e.g., software) and database components. The tool may simplify and streamline various portions of the front end sales process so that the vendor may actively market plural substation solutions to the customer in an efficient manner where those substation solutions are based on customer specified requirements and available substation technology. For instance, the tool introduces a high level of automation to the front end sales process by focusing (e.g., scripting) data collection, conducting automated initial substation development to generate at least one potentially suitable substation configuration, automating the generation of economic and technical data for use in comparing plural substation configurations, and integrating display of substation design with a customer comment and evaluation process. As a result, customer satisfaction may be increased, various phases of the front end sales process may be accomplished faster and with greater accuracy than previously known, and less vendor resources may be utilized, especially in the area of design engineering. As a result, a decrease in the cost of substation offer preparation may be realized.

The tool allows for the collection of substation functional requirements from the customer and information from other data sources using a question and answer script. Based on the collected substation functional requirements, at least one potentially suitable substation configuration may be identified. An expert system may be used for substation configuration identification. The expert system may draw from a database of known substation configurations. A second database may contain modules that may be used to construct each of the substation configurations. Each substation configuration in the substation configuration database may be associated with modules from the substation module database. The expert system may identify potential alternative modules that may be used instead of modules that have been pre-associated with the known substation configurations.

If the expert system identifies two or more potential substation configurations, the front end sales process may include a technical, reliability and/or economic analysis phase to narrow the potential substation configurations to at least one alternative, if not a few alternatives, upon which an initial budget quotation may be made. A graphical user interface (GUI) may be used to display the potential substation configurations. For instance, the GUI may display the potential substation configurations as single line diagrams (SLD). In addition, the GUI may be used to add comments to the SLD associated with a substation configuration. An initial budget quotation with a bill of materials (BOM) and substation drawings may be generated for a selected substation and provided to the customer for evaluation.

If the customer has continued interest in a quoted one of the substation configurations, the SLD and any associated customer comments may be transmitted to the vendor's substation design engineers for further customization of the substation. The additional customization work performed by the design engineers is intended to address any customer functional requirements and/or comments that were not satisfied earlier in the front end sales process. Upon completion of the additional design engineering, the revised substation design may be returned to the vendor's marketing personnel for presentation to the customer. If the customer has any additional comments, those comments may be relayed to the engineering department for additional customization of the substation, if appropriate. Once all of the customer's functional requirements and/or comments are addressed, a firm quotation for the substation project may be presented to the customer and final cost negotiations may be carried out between the vendor and the customer.

### B. System Configuration

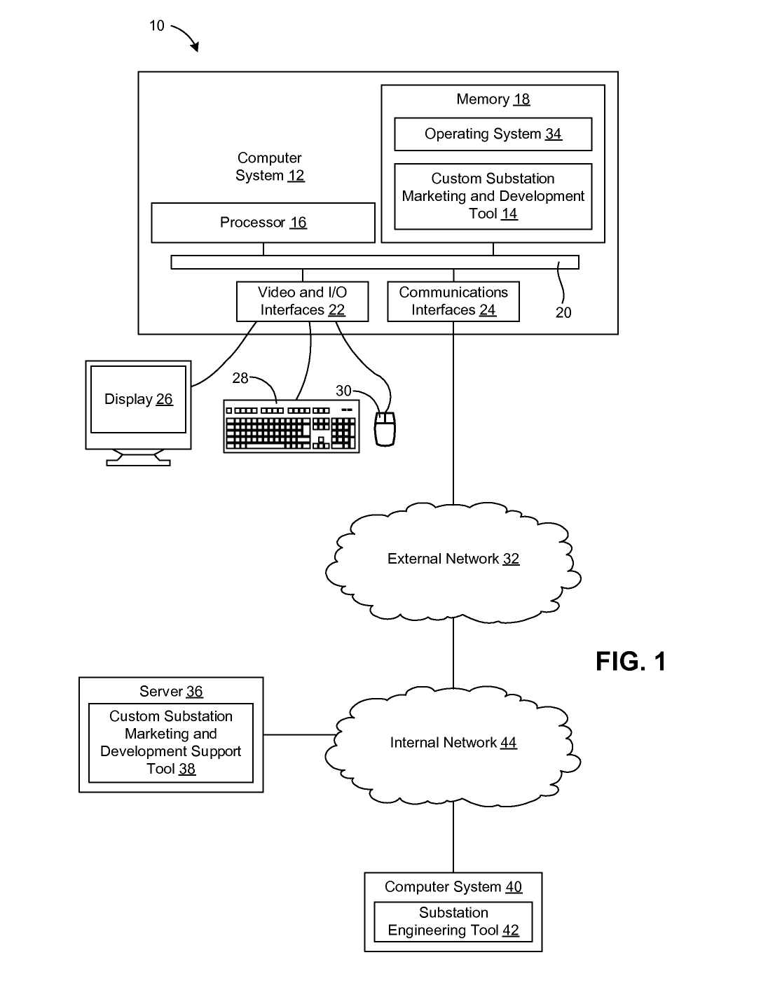

With reference to FIG. 1, illustrated is a schematic block diagram of a computer-based system 10 capable of executing computer applications (e.g., software programs). The computer system 10 may include a computer 12 used, for example, by a marketing representative of a substation vendor to carryout a front end sales process with a customer. The computer 12 may be configured to execute executable portions of a custom substation marketing and development tool 14 and/or to store database portions of the custom substation marketing and development tool 14. As will be described below, the tool 14 may be executed and/or stored in whole or in part by other components of the system 10.

In one embodiment, the custom substation marketing and development tool 14 is embodied as one or more computer programs (e.g., one or more software applications including compilations of executable code) and/or one or more database structures. The computer program(s) and/or databases may be embodied on a machine (e.g., computer) readable medium, such as a magnetic, optical or electronic storage device (e.g., hard disk, optical disk, flash memory, etc.).

To execute the tool 14, the computer 12 may include one or more processors 16 used to execute instructions that carry out a specified logic routine(s). In addition, the computer 12 may have a memory 18 for storing data, logic routine instructions, computer programs, files, operating system instructions, and the like. As illustrated, the tool 14 may be stored by the memory 18. The memory 18 may comprise several devices, including volatile and non-volatile memory components. Accordingly, the memory 18 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 16 and the memory 18 are coupled using a local interface 20. The local interface 20 may be, for example, a data bus with accompanying control bus, a network, or other subsystem.

The computer 12 may have various video and input/output (I/O) interfaces 22 as well as one or more communications interfaces 24. The interfaces 22 may be used to operatively couple the computer system 10 to various peripherals, such as a display 26, a keyboard 28, a mouse 30, a microphone (not shown), a camera (not shown), a scanner (not shown), a printer (not shown), a speaker (not shown) and so forth. The communications interfaces 24 may include for example, a modem and/or a network interface card. The communications interfaces 24 may enable the computer system 10 to send and receive data signals, voice signals, video signals, and the like to and from other computing devices via an external network 32 (e.g., the Internet), a wide area network (WAN), a local area network (LAN), direct data link, or similar systems. The interface between the computer 12 and any operatively interfaced device or network may be wired or wireless.

The memory 18 may store an operating system 34 that is executed by the processor 16 to control the allocation and usage of resources in the computer 12, as well as provide basic user interface features. Specifically, the operating system 34 controls the allocation and usage of the memory 18, the processing time of the processor 16 dedicated to various applications being executed by the processor 16, and the peripheral devices, as well as performing other functionality. In this manner, the operating system 34 serves as the foundation on which applications, such as the tool 14, depend as is generally known by those with ordinary skill in the art. The operating system 34 also controls much of the user interface environment presented to a user, such as features of the overall GUI for the computer 12.

The computer system 10 may include computing devices in addition to the computer 12. For example, the computer system 10 may include a server 36 that stores and/or executes a custom substation marketing and development support tool 38. As will be appreciated, the server 36 may be configured as a typical computer system used to carry out server functions. For instance, the architecture of the server 36 may be similar to the architecture of the computer 12, such as including a processor configured to execute software containing logical instructions that embody the functions of the server 36 and a memory to store such software and related data.

Also, the computer system 10 may include a computer 40 used by one or more substation design engineers to customize a substation configuration identified by the custom substation marketing and development tool 14. To assist the substation design engineer, the computer 40 may store and/or execute a substation engineering tool 42. As will be appreciated, the computer 40 may be configured as a typical computer system used to carry out computing functions. For instance, the architecture of the computer 40 may be similar to the architecture of the computer 12, such as including a processor configured to execute software containing logical instructions that embody the functions of the computer 12 and a memory to store such software and related data.

In the illustrated embodiment, the server 36 and the computer 40 are networked for the exchange of data and information over an internal network 44. For example, the internal network 44 may be a private network of the substation vendor. The computer 12 also may exchange data with the server 36 and/or the computer 40 via the internal network 44. In the illustrated embodiment, the computer 12 interfaces with the internal network 44 over the external network 32. For example, the computer 12 may register or login to the internal network 44 over the Internet, serving as the external network 32. This arrangement may be convenient when the user of the computer 12 appears in person with the computer 12 at the location of the customer, and that location is remote from the vendor's location. In other embodiments or at other times during the front end sales process, the computer 12 may interface directly with the internal network 44. Also, the computer 12 may operate as a stand-alone device during portions of the front and sales process.

In one embodiment, the entire custom substation marketing and development tool 14 is resident in and/or executed by the computer 12. In other embodiments, some or all of the custom substation marketing and development tool 14 is resident in and/or executed by the server 36. Portions of the tool 14 that are not resident in or executed by the computer 12 may be considered to form part of the support tool 38. Those portions of the tool 14 that form part of the support tool 38 may be hosted by the server 36 and accessed on an as needed basis by the computer 12. Thus, all or a portion of the tool 14 may be distributed in portions of the computer system 10 other than the computer 12. In a specific example, a substation configuration database and a substation module database that form part of the tool 14 may be hosted by the server 36. In another alternative, master copies of various database components of the tool 14 may be hosted by the server 36 and copies of the databases may be stored by the computer 12 so that the computer 12 may operate independently from the remainder of the computer system 10. Furthermore, functional components of the tool 14 may be carried out by the server 36. For instance, the server 36 may be configured to host an Internet-style website accessible by the computer 12. Through the website, the user of the computer 12 may enter information such as a customer's substation functional requirements and the server 36 may execute an expert system component of the tool 14 to identify one or more substation configurations that are transmitted back to the computer 12 for additional processing and/or display.

It will be apparent to a person having ordinary skill in the art of computer programming, and specifically in application programming for data collection, data processing and/or expert systems, how to program a computer system 10 to operate and carry out logical functions associated with the tool 14 and/or support tool 38. Accordingly, details as to specific programming code and database structures have been left out for the sake of brevity. Also, while the tool 14 and/or support tool 38 are executed by respective computers in accordance with a preferred embodiment of the invention, such functionality could also be carried out via dedicated hardware, firmware, software, or combinations thereof, without departing from the scope of the invention.

### C. Custom Substation Marketing and Development Tool

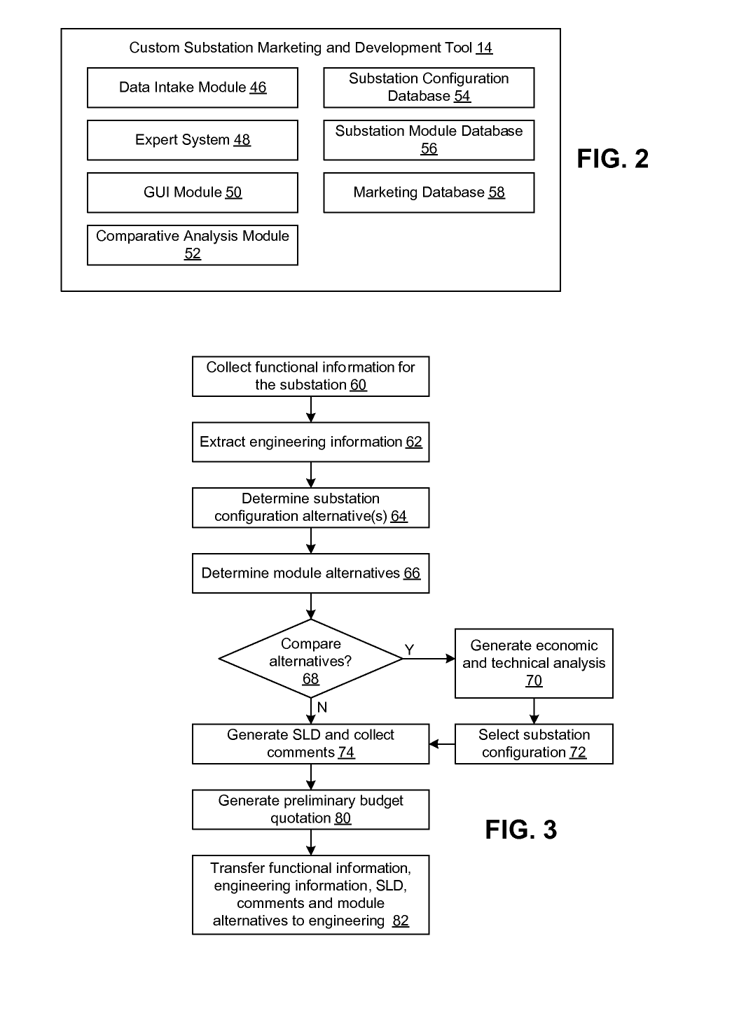

With additional reference to FIG. 2, illustrated is a functional block diagram of exemplary components for the custom substation marketing and development tool 14. As indicated, some or all of the components for the tool 14 may be omitted from the tool 14 as executed and/or stored by the computer 12 in favor of executing and/or storing the omitted components with the server 36 as part of the custom substation marketing and development support tool 38. However, for purposes of providing a concise description, the custom substation marketing and development tool 14 will be described in an undistributed arrangement that is executed and stored by the computer 12.

The custom substation marketing and development tool 14 may include various modules of code relating to certain functions of the tool 14. Exemplary modules include a data intake module 46, an expert system 48, a graphical user interface module 50 and a comparative analysis module 52. The functions of these modules and other functions of the tool 14 will be described in greater detail below. The various modules of the tool 14 may interact with each other, other software programs and/or various databases. Exemplary databases that form a part of the tool 14 may include a substation configuration database 54, a substation module database 56 and a marketing database 58. The data stored by various databases of the tool 14 will be described in greater detail below.

### D. Custom Substation Marketing

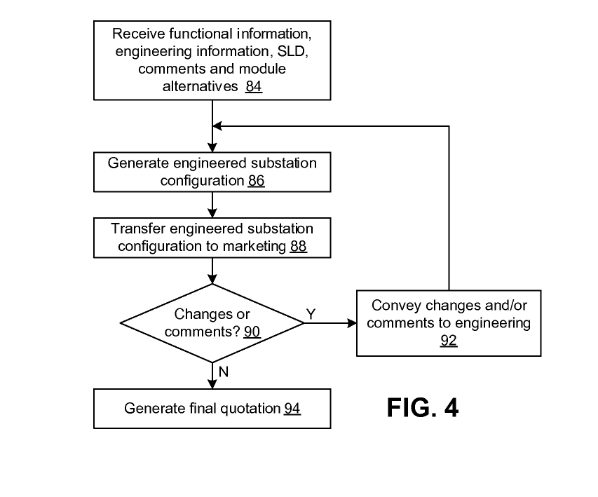

With additional reference to FIGS. 3 and 4, illustrated are logical operations to implement an exemplary method of marketing and/or developing a custom substation. The exemplary method may be carried out by executing an embodiment of the custom substation marketing and development tool 14, for example. Thus, the flow charts of FIGS. 3 and 4 may be thought of as depicting steps of a method carried out by the computer system 10. Although FIGS. 3 and 4 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

### D(1). Data Collection and Derivation

The logical flow for the custom substation marketing and development tool 14 may begin in block 60 where information for the proposed substation project is collected. Collecting information may include interviewing the customer and gathering data from other sources, such as local authorities and/or regulators, climate databases and so forth. The collected information may be assembled and/or processed to form the customer's functional requirements for the substation. As used herein, the term “functional information” includes data relating to one or more of the customer's functional requirements, the customer's preferences or information from other sources that may effect aspects of the substation design. Functional information may include raw data (e.g., the answers to questions as described below) and/or processed data.

To assist in the collection of functional information for the proposed substation, the data intake module 46 may present a series of questions to the vendor and/or the customer. In one embodiment the questions are presented to the vendor and/or the customer using a graphical user interface and the responses may be entered by typing and/or making selections from a menu of predetermined possible answers. The answers to the questions and any functional requirements derived from the answers may be recorded in the marketing database 58 for future reference and for use by other processes of the tool 14. For instance, substation design engineers may be interested in the answers given to certain questions or the stored information may be used in conjunction with the front-end sales process for another substation. The collected data may be stored in preformatted templates.

Presentation of questions may follow a script embodied by the data intake module 46. For example, certain basic information concerning the operability of the proposed substation may be collected in a specified order. Also, the responses to certain questions may be monitored so that appropriate follow-on questions may be presented. That is, the presentation of some questions may be dependent on the answer given to a previous question.

The collection of information in block 60 may include a collection of technical data related to the proposed substation. Technical data includes, but is not limited to, the incoming voltage, the outgoing voltage, the power ratings for certain equipment, the number of incoming transmission lines, the number of outgoing transmission lines, incoming transmission line characteristics (e.g., overhead lines supported by towers or buried lines), outgoing transmission line characteristics (e.g., overhead lines or buried lines), the type of circuit breakers that the customer prefers, various equipment preferences, and so on.

The collection of information block 60 may include a collection of location related data associated with the proposed substation. Location related data may include the size and shape of an available substation site. Location related data also may include applicable government and/or administrative regulations established for substations at the proposed substation site. Location related data also may include environmental information, such as the altitude of the proposed substation site, climate conditions, average rainfall, temperature and wind for the proposed substation site, and any other applicable environmental, climate, weather or ambient information.

After relevant information for the proposed substation has been collected in block 60, the logical flow may proceed to block 62 where the collected information may be processed to derive engineering information from the collected functional information. Engineering information is data that is useful in the selection and/or design of a substation and which follows from the functional information. Some engineering information may be the same as the functional information and other engineering information may be calculated based upon the functional information. For instance, if the customer has specified a certain number of distribution lines at a certain voltage and each line's load or current rating, the power rating of a power transformer for the substation may be calculated. Once derived, the engineering information may be stored for future reference by other processes of the tool 14, evaluation by the customer, use by substation design engineers, and so forth.

### D(2). Determination of Potential Substation Configuration(s)

Proceeding to block 64, one or more substation configurations that are likely to be suitable for the customer's specified functional requirements may be determined. A substation configuration is an arrangement for a substation. In one embodiment, the database of substation configurations 54 stores a collection of known (e.g., predetermined) substation configurations. The known substation configurations may be based on substations that are known in the art, that have been generated by an automated substation configurator, that have be previously built or designed by the vendor, and/or that have been derived from some other source. It is contemplated that there may be a thousand or more substation configurations stored in the substation configuration database 54. Of course, the substation configuration database 54 could store fewer than a thousand substation configurations.

Each substation configuration stored in the database is a complete substation arrangement. Some of the stored substation configurations may be appropriate for the substation functional requirements set forth by the user, but it is probable that the majority of the substation configurations in the database may not be appropriate for the proposed substation project. The substation configurations may be thought of as preliminary designs and it is contemplated that substation configurations determined to be appropriate for proposed substation project may not meet all customer's substation functional requirements. Rather, the substations configurations provide base models upon which technical, reliability and/or economic evaluation may be made, as will be described below in greater detail. As also described below, customization of a selected one of the substation configurations from the database may be carried out to satisfy and/or address all customer functional requirements and comments.

Associated with each substation configuration may be information regarding substation markets for which the substation may be suitable. A substation market may be thought of as a convergence of customer related factors, such as intended electricity use, geographic location, environmental conditions, prevailing government regulations, and so forth. Thus information regarding to suitability for each substation for various countries, states and/or regions, various regulations, varying altitudes and/or weather conditions, various end users, and so forth may be stored as part of the substation configuration database 54. In this manner, the vendor's knowledge as to the suitability of a substation configuration for a specific market may be capitalized. For instance, a substation configuration that is appropriate for a wind generator farm may differ from a substation configuration that is appropriate for a steel mill. As another example, a substation configuration that is appropriate for a residential community in the desert southwest of the United States (e.g., Phoenix, Ariz.) may differ from a substation configuration that is appropriate for a residential community in the upper Midwest of the United States (e.g., Minneapolis, Minn.).

Each substation configuration that is stored in the substation configuration database may be made up of a predetermined set of modules. Each module is a collection of components that, when assembled, accomplish a certain function (or functions) of the substation. One module for a given task may be swapped with a module that performs the same task, provided that the new module is compatible with the overall substation configuration. The various substation modules may be stored in the substation module database 56. It is contemplated that there may be tens of thousands of modules stored in the substation module database 56. Of course, there may be fewer modules stored in the substation module database 56.

Each module may be used in one or more substation configuration. Accordingly, information as to the substation configurations in which each module may be used may be stored. For instance, data may be stored with each module that indicates the identity of each substation configuration in which the module may be used. In another embodiment, data may be stored with each substation configuration that indicates the identity of all the modules that may be used in the substation configuration. In yet another embodiment, a separate database may be maintained that stores information setting forth the possible associations between the modules and the substation configurations.

Exemplary categories of modules include, but are not limited to, breaker modules, transformer modules, bus modules, connection modules, protection modules and switching modules. Most substation configurations will be made up of about ten to about fifteen modules, but some substation configurations may have more or fewer modules.

The expert system 48 may be configured to determine one or more substation configuration alternatives that may be suitable for the customer based on the information collected in block 60 and/or derived in block 62. For instance, the expert system 48 may be programmed with rules to search through the substation configurations stored by the substation configuration database 54 to determine which stored substation configurations match or best match the collected information relating to the substation (e.g., the customer's functional requirements and information from external sources). The expert system 48 may be programmed to narrow the number of possible substation configurations to a predetermined maximum number of alternatives.

In one embodiment, the expert system 48 may be programmed to determine the substation configurations that may satisfy a minimum percentage of the customer's functional requirements. For example, the expert system 48 may be programmed to identify the substation configurations from the substation configuration database 54 that meet at least seventy percent of the customer's functional requirements. In another embodiment, substation configurations that meet at least seventy five percent of the customer's functional requirements may be identified and, in another embodiment, substation configurations that meet at least eighty percent of the customer's functional requirements may be identified.

As indicated, the expert system 48 may apply various rules to determine which substation configurations may satisfy some of the criteria for the customer's substation project. In one embodiment, the rules may involve matching the criteria (e.g., the data collected and/or determined in blocks 60 and 62) to properties of each substation configuration in the substation configuration database 54. Therefore, in one embodiment, the substation configuration database 54 maintains information as to the technical and functional capabilities of each substation configuration. For instance, functional requirements, such as the number of connected transmission and/or distribution lines, the power handling capacity, and so on, may be matched against stored properties of each substation configuration. Similarly, the customer's intended use for electricity derived from the substation may be considered by the expert system 48 and compared to data stored in the substation configuration database 54. Intended use may be specified by categorizing the type of end user for the electricity, such as residential user, general commercial user (e.g., office buildings), manufacturer, oil refiner, electricity generation and so on. Also, factors relating to the environmental conditions and geographical location of the substation site may be matched against stored properties of each substation configuration.

The customer's functional requirements may be prioritized and the expert system 48 may generate results based on the prioritization. For instance, a substation configuration that satisfies a high priority functional requirement may be selected over a substation configuration that satisfies numerically more functional requirements, but that have relatively low priority.

Multiple substations configurations that have the same basic arrangement, but a different combination of modules, may be selected. For instance, two substations configurations that are of the same basic arrangement may appear in the results, but one of the substation configurations includes modules have newly developed technology and the other of the substation configurations includes modules having older, conventional technology.

It is contemplated that the expert system 48 may be configured to identify practical substation configurations for nearly any substation market. As indicated a substation market may be thought of as a convergence of customer related factors, such as intended electricity use, geographic location, environmental conditions, prevailing governmental regulations, and so forth. Thus, the vast majority of global markets for substations may be served by the custom substation marketing and development tool 14.

The results from carrying out block 64 may be stored in a work file for the substation project or in the marketing database 58. The results include an identification of each substation configuration that the expert system 48 identified as having the potential for use in implementing the substation project. In a preferred embodiment, the identified substation configurations are taken directly from the substation configuration database 54 and the expert system 48 does not make any modifications to the pre-stored substation configurations. In other embodiments, the expert system 48 may be configured to construct one or more potential substation configurations from individual modules using various design rules in response to the collective information from block 60 and the derived information from blocks 62.

The logical flow may proceed to block 66 where the custom substation marketing and development tool 14 may identify each module that may be used in the substation configurations that were identified in block 64. As indicated, it may be possible to modify a substation configuration from the substation configuration database 54 by replacing a module that is contained in the substation configuration with a different module that implements the same or similar tasks. The alternative modules may be identified by searching the substation module database 56. For instance, the expert system 48 may be configured to evaluate the physical and performance characteristics of the modules stored by the substation module database 56 and identify possible alternatives to the modules that make up the substation configurations identified in block 64. In other embodiments, alternative modules may have been previously identified and those identities may have been stored with the substation configuration in the substation configuration database 54, stored with the modules in the substation module database 56, or stored in a separate database. The results from carrying out block 66 may be stored in a work file for the substation project or in the marketing database 58.

### D(3). Selection of Substation Configuration for Budget Quotation

From block 66, the logical flow may proceed to block 68 in which a determination is made as to whether the customer is interested in a single one of the substation alternatives identified in block 64 or would like to do comparative analysis of the substation alternatives identified in block 64. If alternative analysis is desired, a positive determination may be made in block 68. If the customer is interested in only one substation alternative or if the execution of block 64 resulted in a single substation configuration, a negative determination may be made in block 68.

Upon a positive determination block 68, the logical flow may proceed to block 70 in which an economic, reliability and/or technical comparative analysis of all or some of the substation configuration alternatives identified in block 64 may be made. As indicated, the custom substation marketing and development tool 14 may include a comparative analysis module 54 that is configured to collect technical data and calculate economic data that may be useful to the customer in narrowing the number of substation configurations for which a budget quotation is desired. Technical data for the comparison may be stored with each of the potential substation configurations in the substation configuration database 54, stored with each of the modules associated with the substation configuration in the substation module database 56, and/or may be extracted from equipment specifications for the components in the substation configuration.

Economic data for the comparison may be stored and/or calculated based on known economic parameters and information collected in block 60. In general, the economic data used in the comparison relates to lifecycle costs for the substation configurations identified in block 64. Lifecycle costs may include, for example, investment costs, site preparation costs, operation and maintenance costs, costs of power interruptions and so forth. Data that may be useful in calculating these costs include, but is not limited to, the expected length of the substation lifecycle, estimated interest rates over the substation lifecycle, transportation costs to the substation site, and labor and material costs. This type of data may be collected during the information collection portion of the front and sales process (e.g., as may be carried out in block 60). Other information used in lifecycle cost calculations may include data derived from equipment specifications for the components found in the substation configuration. For example, some of the lifecycle costs calculations may be a function of known equipment reliability rates.

In addition, knowledge and experience of the vendor and of the customer may be used to calculate at least some of the lifecycle costs for the substation configurations identified in block 64. For instance, the costs of power interruptions to the customer may be based on the type of user and data collected by the vendor and/or the customer. Some customers may be impacted greater by the frequency of power interruptions while other customers may be impacted greater by the duration of power interruptions. For instance, power interruptions, regardless of the duration, may be relatively costly for an oil refinery where a power interruption leads to a lengthy shutdown in operations. But a manufacturer that can reset operations rapidly after a power interruption may have little economic losses due to a single power interruption of brief duration.

In the event where some of the data to calculate lifecycle costs for the specific customer is unknown, the comparative analysis module may be configured to generate lifecycle costs based on general factors, such as the location of the planned substation site and the type of industry in which the customer is engaged.

The comparative analysis module 54 may be configured to present the economic, reliability and/or technical information to the customer in any suitable format. For instance, comparative spreadsheets, charts and/or reports may be generated. Such economic, reliability and/or technical information may be displayed on the display 26, printed with a printer and/or stored in a work file related to the proposed substation project or in the marketing database 58.

Next, in block 72, the customer may select one or more of the substation configurations for further review and possible budget quotation. In addition, the tool 14 may allow the customer to rank the identified substation configurations in an ordered list and those rankings may be stored in a work file or in the marketing database 58. Should the customer decide to pursue a substation configuration different than the substation configuration selected in block 72 the ordered list of substation configurations may be consulted to select which one of the substation configurations to next evaluate in more detail.

### D(4). Display and Review of the Selected Substation Configuration(s)

Following a negative determination in block 68 or after a substation configuration(s) is selected in block 72, the logical flow may proceed to block 74 where the substation configuration is displayed. The substation configuration may be displayed using the GUI module 50 of the custom substation marketing and development tool 14. In one embodiment, the substation configuration is displayed as a single line diagram (e.g., a high level electrical schematic diagram). In the single line diagram, each module of the substation configuration may be identified.

The GUI module 50 may allow user interaction with the display of the substation configuration. For example, a customer may add comments to the substation configuration. Any added comments may be stored with the substation configuration in a work file or in the marketing database 58. The comments may be generally directed to the substation configuration or directed to a specific portion of the substation configuration, such as one of the modules or an individual component of one of the modules.

Another exemplary user interaction with the display of the substation configuration is to view details for a selected one of the modules from the substation configuration. For instance, using the mouse 30, the user may select a module and invoke a command to display the component parts of module (e.g., a parts list), an electrical schematic diagram for the module, technical information related to module, a list of alternative modules that may be used in the substation configuration to accomplish the same or similar tasks as the selected module, stored customer comments regarding the module, vendor notes regarding the module and/or any other data that has been associated with the selected one of the modules.

In one embodiment, the GUI module 50 may rely on a commercially available drawing program, such as Microsoft Visio or AutoCAD, for rendering graphics and/or enabling the above described user interaction with the single line diagram of the substation configuration.

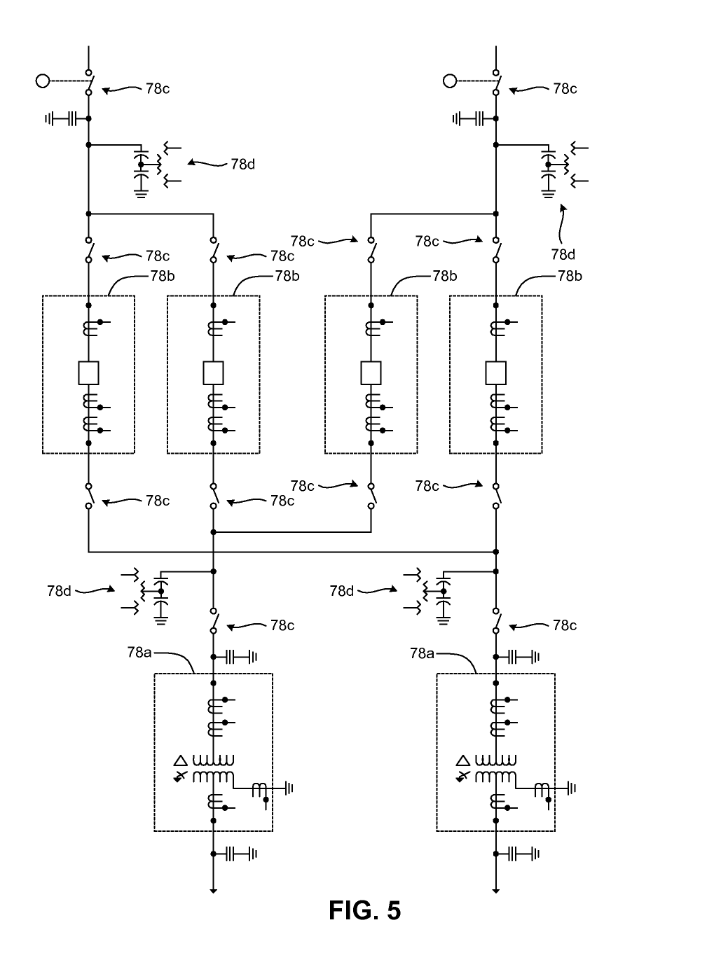

With additional reference to FIG. 5, illustrated is an exemplary single line diagram of a representative substation configuration 76 that is made up from a plurality of individual modules 78. As will be understood, the substation configuration 76 and modules 78 depicted in FIG. 5 are a representative example. Modules present in the illustrated representation include transformer modules 78a, breaker modules 78b, switching modules 78c, and protection modules 78d. Some modules may be shown in the single line diagram in a distributed form. For instance, some of the identified switching modules 78c may be grouped as part of a single switching module.

An actual substation configuration and/or a graphical portrayal of the substation configuration for a customer's proposed substation project may differ from that depicted. The generation of a displayable single line diagram may be automated by the custom substation marketing and development tool 14, may be derived from a pre-established drawing stored by the substation configuration database 54 and/or may be manually generated by the user (e.g., by dragging, dropping and connecting graphical representations of appropriate substation modules).

Next, in block 80, the vendor may prepare a preliminary budget quotation for the substation configuration currently under evaluation. In one embodiment, the custom substation marketing and development tool 14 may be configured to automate the quotation process. For instance, pre-determined pricing data for substation site preparation, construction costs, and parts may be used to generate a budget estimate. Pricing data may be adapted for the economic conditions at the specific substation site, considering factors such as transportation costs, local labor costs, insurance, environmental considerations and so on. In addition to a preliminary budget quotation, the vendor may use the custom substation marketing and development tool 14 to prepare substation drawings and layout diagrams, a bill of materials (BOM), and so forth.

The description of the logical flow with respect to blocks 74 and 80 has been directed to the display and evaluation of a single substation configuration. It will be appreciated, however, that two or more substation configurations may be displayed and/or evaluated in block 74 and 80.

### D(5). Substation Configuration Customization

Assuming that the customer is interested in pursuing one or more of the substation configurations, the substation configuration(s) may be customized so that the customer's functional requirements and/or comments may be addressed and a detailed budget quotation may be generated with more precision than the quotation of block 80. Customization of a substation configuration may be performed by one or more design engineers using, for example, the computer 40.

To provide the design engineer with sufficient data to customize the substation configuration for the customer, the logical flow may proceed to block 82. In block 82, the information collected in block 60, the engineering information derived in block 62, the SLD generated in block 74 along with any appended comments, the module alternatives identified in block 66, and any other appropriate data or information that has been generated for the proposed substation project may be transferred to the computer 40. For instance, such data may be uploaded from the computer 12 to the computer 40. In another embodiment, such data may be transferred from the computer 12 to the server 36 (if not already present on the server 36) for access by the computer 40. In one embodiment, the data transferred to the engineering department may be merged into an engineering database from which the design engineer may adjust the substation configuration.

With continued reference to FIGS. 3 and 4, the data transferred in block 82 may be received by the engineering department in block 84. Thereafter, in block 86, the engineering department may use the single line diagram of the substation configuration and any other appropriate data sources to customize the substation configuration and generate an engineered substation solution for the customer. It is contemplated that during the customization of the substation configuration that all or nearly all of the customer's functional requirements that were not previously met by the selected substation configuration that was transferred to the engineering department in block 82 may be satisfied. For example, if the selected substation configuration as derived from the substation configuration database 54 meets about seventy percent to about eighty percent of the customer's functional requirements, the remaining twenty percent to thirty percent of the customer's functional requirements may be addressed through the detailed engineering process. It is contemplated that generating possible alternative modules for the substation configuration in block 66 and providing the identity of those alternatives to the engineering department may streamline the engineering work involved in customizing the substation configuration.

The engineered substation configuration resulting from block 86 may be transferred to the marketing personnel for presentation to the customer in block 88. For instance, the engineered substation configuration may be uploaded to the server 36 for access by the computer 12 or the engineered substation configuration may be transferred directly to the computer 12.

The marketing representative for the vendor may present the engineered substation configuration to the customer for review. Should the customer have any comments and/or changes regarding the engineered substation configuration in block 90, the comments and or changes may be relayed back to the engineering department of the vendor in block 92. Following block 92 the customization of the substation configuration may continue through blocks 86 through 90 until the customer has no additional changes or comments regarding the substation configuration. If the customer has no additional changes or comments regarding the substation configuration, the logical flow may proceed from block 92 to block 94 where the marketing representative may present a firm budget quotation for the substation to the customer. Thereafter, price and/or term negotiation regarding the sale of the substation by the vendor to customer may be carried out to conclude the front end sales process.

### E. Conclusion

Although embodiments of the invention have been shown and described, it is understood that equivalents and modifications will occur to others in the art upon the reading and understanding of the specification. The present invention includes all such equivalents and modifications, and is limited only by the scope of the following claims.

What is claimed is:

1. A computer implemented method of marketing an electricity distribution and transmission substation to a customer by a substation vendor, comprising:
collecting functional information relating to intended use and location of the substation; and
identifying at least one substation configuration from a database of plural substation configurations, the identified substation configurations having at least some suitability for satisfying the collected functional information, and wherein the identification is made by an expert system that matches the functional information with predetermined characteristics of each of the plural substation configurations.

2. The method of claim 1, wherein the predetermined characteristics of each of the plural substation configurations includes at least one substation market for the substation configuration.

3. The method of claim 2, wherein each substation market is based on at least one factor selected from intended electricity use, geographic location, environmental conditions, government regulations and combinations thereof.

4. The method of claim 1, wherein each of the plural substation configurations is made up of a predetermined set of modules.

5. The method of claim 4, further comprising, for at least one of the identified substation configurations, determining an alternative module for one of the predetermined modules that makes up the identified substation configuration.

6. The method of claim 1, further comprising converting the collected functional information to engineering information, the expert system using the engineering information as the basis for the matching of the functional information with the predetermined characteristics of each of the plural substation configurations.

7. The method of claim 1, further comprising displaying a graphical representation of a selected one of the identified substation configurations.

8. The method of claim 7, wherein the displaying is associated with a graphical user interface that accepts and stores a comment associated with the displayed graphical representation.

9. The method of claim 1, further comprising generating a preliminary budget quotation for a selected one of the identified substation configurations.

10. The method of claim 1, further comprising customizing a selected one of the identified substation configurations based on the functional information to generate an engineered substation configuration that is adapted for the customer.

11. The method of claim 10, further comprising generating a budget quotation for the engineered substation configuration.

12. The method of claim 1, wherein the collecting of function information includes receiving answers to questions contained in an automated question script.

13. The method of claim 12, wherein the functional information includes at least one of the answers or data derived by processing the answers.

14. The method of claim 1, further comprising calculating lifecycle costs of the identified substation configurations based on the functional information and presenting the calculated lifecycle costs to the customer as part of a comparative analysis of the identified substation configurations.

15. A computer implemented method of marketing an electricity distribution and transmission substation to a customer by a substation vendor, comprising:
storing a substation configuration database containing plural predetermined substation configurations; and
for each substation configuration, associating one or more substation customer markets for which the substation configuration has at least some suitability, the associated substation customer markets based on at least one factor selected from intended electricity use, geographic location, environmental conditions, government regulations and combinations thereof.

16. The method of claim 15, wherein each of the plural predetermined substation configurations is made up of a predetermined set of modules.

17. The method of claim 16, wherein for at least some of the substations configurations the method further includes storing an identity of an alternative module that is compatible with the substation configuration as a potential replacement to a module from the corresponding predetermined set of modules.

18. A computer implemented substation marketing and development tool for use in marketing a custom electricity distribution and transmission substation to a customer by a substation vendor, comprising:
a substation configuration database stored by a memory, the database containing plural predetermined substation configurations; and
a program embodied on a machine readable medium, the program containing executable logic to:
collect functional information relating to intended use and location of the substation; and
identify at least one substation configuration from the database that has at least some suitability for satisfying collected functional information, and wherein the identification is made by an expert system that matches the functional information with predetermined characteristics of each of the plural substation configurations.

19. The computer implemented substation marketing and development tool of claim 18, wherein the predetermined characteristics of each of the plural substation configurations includes at least one substation market for the substation configuration.

20. The computer implemented substation marketing and development tool of claim 19, wherein each substation market is based on at least one factor selected from intended electricity use, geographic location, environmental conditions, government regulations and combinations thereof.

21. The computer implemented substation marketing and development tool of claim 18, wherein each of the plural substation configurations is made up of a predetermined set of modules.

22. The computer implemented substation marketing and development tool of claim 21, wherein the program further includes executable logic to determine an alternative module for one of the predetermined modules that makes up at least one of the identified substation configurations.

23. The computer implemented substation marketing and development tool of claim 18, wherein the program further includes executable logic to convert collected functional information to engineering information, the expert system configured to use the engineering information as the basis for the matching of the functional information with the predetermined characteristics of each of the plural substation configurations.

24. The computer implemented substation marketing and development tool of claim 18, wherein the program further includes executable logic to display a graphical representation of a selected one of the identified substation configurations.

25. The computer implemented substation marketing and development tool of claim 24, wherein the program further includes executable logic to accept and store a comment in association with the displayed graphical representation.

26. The computer implemented substation marketing and development tool of claim 18, wherein the program further includes executable logic to generate a budget quotation for a selected one of the identified substation configurations.

27. The computer implemented substation marketing and development tool of claim 18, wherein the logic to collect functional information generates an automated question script.

28. The computer implemented substation marketing and development tool of claim 18, wherein the program further includes executable logic to calculate lifecycle costs of the identified substation configurations based on the functional information and present the calculated lifecycle costs to the customer as part of a comparative analysis of the identified substation configurations.
